(19) United States
(12) Patent Application Publication
(10) Pub. No.: US 2022/0307862 A1
(43) Pub. Date: Sep. 29, 2022

(54) STEP COUNTING METHOD OF EARPHONE, EARPHONE AND NON-TRANSITORY STORAGE MEDIUM

(71) Applicant: GOERTEK INC., Weifang City (CN)

(72) Inventor: Huan LI, Weifang City (CN)

(21) Appl. No.: 17/840,783

(22) Filed: Jun. 15, 2022

Related U.S. Application Data
(63) Continuation of application No. PCT/CN2021/121277, filed on Sep. 28, 2021.

(30) Foreign Application Priority Data
Jan. 27, 2021 (CN) 202110115096.6

(51) Int. Cl. G01C 22/00; H04R 3/04; H04R 1/08; H04R 1/10

(52) U.S. Cl. CPC G01C 22/006; H04R 3/04; H04R 1/08; H04R 1/1041

(57) ABSTRACT

Disclosed is a step counting method of an earphone, an earphone and a storage medium. The method acquires vibration pulse signals through the feedback microphone of the earphone, determines valid pulse signals according to the vibration pulse signals, and counts steps according to the number of valid pulse signals. By utilizing the feedback microphone of the earphone, the earphone has an audio playing function and a step counting function, so that when the user exercises in the state of wearing the earphone, the user does not need to wear another step counting equipment for step counting, thereby the problem that in the related art, the user needs to wear multiple electronic equipment when doing exercise is solved. Further, the feedback microphone of the earphone is used for step counting, and the user does not need to purchase another pedometer equipment, thus the cost for counting steps can be reduced.

### CROSS REFERENCE TO RELATED APPLICATIONS

The present application is a continuation application of International application No. PCT/CN2021/121277, filed on Sep. 28, 2021, which claims priority to Chinese patent application No. 202110115096.6, entitled “Step Counting Method Of Earphone, Earphone And Storage Medium” filed on Jan. 27, 2021, the entire contents of the aforementioned applications are incorporated herein by reference.

### TECHNICAL FIELD

The present application relates to the technical field of step counting, in particular to an step counting method of an earphone, an earphone and a non-transitory storage medium.

### BACKGROUND

Based on health requirements of modern people, the intelligent mobile phone and the intelligent wrist strap both have a step counting function, and those equipment basically includes a gyroscope, a gravity sensor, an acceleration sensor and the like to cooperate to realize the step counting function.

With the introduction of relevant regulations on sound output of electronic products in public places, the earphone has always been carried by the user. In addition, during exercise, in order to record the motion state of the user, the user needs to wear an aforementioned terminal which has the step counting function or a wearable device for sports to record the steps of the user, thus, when the user enjoys music through the earphone during exercise, the user needs to wear a plurality of electronic devices if he/she wants to know his/her steps. How to reduce the electronic devices worn by the user is an urgent problem to be solved.

### SUMMARY

The main purpose of the application is to provide an step counting method of an earphone, an earphone and a non-transitory storage medium, and aims to solve the technical problem of how to reduce the number of electronic equipment worn by a user during exercise.

In order to achieve the above purpose, the present application provides an step counting method of an earphone. The step counting method of the earphone is applied to an earphone, the earphone includes a feedback microphone, and the step counting method of the earphone includes:

acquiring vibration pulse signals through the feedback microphone of the earphone;

determining valid pulse signals according to the vibration pulse signals, and counting steps according to a number of the valid pulse signals.

Optionally, the operation of determining valid pulse signals according to the vibration pulse signals includes:

acquiring amplitudes of the vibration pulse signals, and determining whether the amplitudes of the vibration pulse signals are larger than or equal to a preset amplitude threshold;

in responding to that the amplitudes of the vibration pulse signals are larger than or equal to the preset amplitude threshold, determining that the vibration pulse signals are the valid pulse signals.

Optionally, the operation of counting the steps according to the number of valid pulse signals includes:

incrementing a number of steps by one each time an valid pulse signal is determined.

Optionally, the earphone further includes a high-pass filter, and before the operation of acquiring the vibration pulse signals through the feedback microphone of the earphone, the method further includes:

receiving original pulse signals through the feedback microphone of the earphone;

filtering the original pulse signals through the high-pass filter to obtain the vibration pulse signals.

Optionally, after the operation of determining the valid pulse signals according to the vibration pulse signals, and counting the steps according to the number of valid pulse signals, the method further includes:

determining whether a number of valid pulse signals in a first preset duration is larger than or equal to a preset number threshold;

in responding to that the number of valid pulse signals in the first preset duration is larger than or equal to the preset number threshold, transmitting a number of steps determined according to the number of valid pulse signals in the first preset duration to a mobile terminal in communication with the earphone, for the mobile terminal to update the number of steps of a wearer.

Optionally, after the operation of determining the valid pulse signals according to the vibration pulse signals, and counting the steps according to the number of valid pulse signals, the method further includes:

transmitting vibration pulse signals acquired by the earphone in a second preset duration to the mobile terminal in communication with the earphone, for the mobile terminal to determine strengths of footsteps of the wearer in the second preset duration according to an amplitude of each vibration pulse signal in the second preset duration, and output a footstep health prompt according to the strengths of the footsteps.

Optionally, after the operation of determining the valid pulse signals according to the vibration pulse signals, and counting the steps according to the number of valid pulse signals, the method further includes:

transmitting vibration pulse signals acquired by the earphone in a third preset duration to the mobile terminal in communication with the earphone, for the mobile terminal to determine a walking speed of the wearer in the third preset duration according to a pulse period of each vibration pulse signal in the third preset duration, and output a walking prompt according to the walking speed.

Optionally, before the operation of acquiring the vibration pulse signals through the feedback microphone of the earphone, the method further includes:

detecting whether the earphone is worn;

in responding to that the the earphone is worn, executing the acquiring the vibration pulse signals through the feedback microphone of the earphone.

Further, in order to achieve the above purpose, the present application further provides an earphone, the earphone includes a feedback microphone, a memory, a processor and a step counting program of the earphone stored in the memory and executable by the processor, wherein when the step counting program of the earphone is executed by the processor, the operations of the step counting method of the earphone described above are implemented.

Further, in order to achieve the above purpose, the present application further provides a non-transitory storage medium storing a step counting program of an earphone, wherein when the step counting program of the earphone is executed by a processor, the operations of the step counting method of the earphone described above are implemented.

The present application acquires vibration pulse signals through the feedback microphone of the earphone, determines valid pulse signals according to the vibration pulse signals, and counts steps according to the number of valid pulse signals. By utilizing the feedback microphone of the earphone, the earphone has an audio playing function and a step counting function, so that when the user exercises in the state of wearing the earphone, the user does not need to wear another step counting equipment for step counting, thereby the problem that in the related art, the user needs to wear multiple electronic equipment when doing exercise and the user experience of counting steps is poor is solved. Further, the feedback microphone of the earphone is used for step counting, and the user does not need to purchase another pedometer equipment, thus the cost for counting steps can be reduced.

### BRIEF DESCRIPTION OF THE DRAWINGS

FIG. 1 is a schematic structural diagram of a hardware running environment of an earphone according to embodiments of the present application.

FIG. 2 is a schematic flowchart of a step counting method of the earphone according to a first embodiment of the present application.

FIG. 3 is a schematic diagram of a medium-frequency pulse signal or a high-frequency pulse signal received by the earphone according to the present application.

FIG. 4 is a schematic diagram of continuous medium-frequency pulse signals or high-frequency pulse signals received by the earphone and generated by walking according to the present application.

FIG. 5 is a schematic diagram of part of the step counting method of the earphone according to an embodiment of the present application.

FIG. 6 is a schematic diagram of part of the step counting method of the earphone according to an embodiment of the present application.

FIG. 7 is a schematic diagram of part of the step counting method of the earphone according to an embodiment of the present application.

FIG. 8 is a schematic diagram of part of the step counting method of the earphone according to an embodiment of the present application.

FIG. 9 is a schematic diagram of part of the step counting method of the earphone according to an embodiment of the present application.

The realization of the objectives, functional features and advantages of the present application will be further explained with reference to the accompanying drawings in combination with the embodiment.

### DETAILED DESCRIPTION OF THE EMBODIMENTS

It should be understood that the specific embodiments described herein are only used to explain the present application, and are not intended to limit the present application.

It should be noted that during exercise, in order to record the state of the user, the user needs to wear an terminal which has the step counting function or a wearable device for sports to record the steps of the user, thus, when the user enjoys music through the earphone during exercise, the user needs to wear a plurality of electronic devices if he/she wants to know his/her steps. How to reduce the electronic devices worn by the user is an urgent problem to be solved.

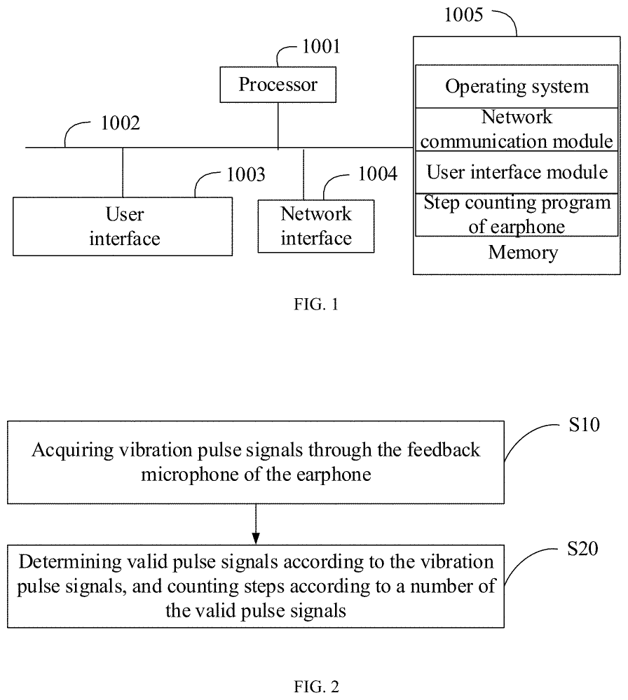

Based on the above-mentioned defects, the present application provides an earphone. Referring to FIG. 1, FIG. 1 is a schematic structural diagram of a hardware running environment of an earphone according to an embodiment of the present application.

As shown in FIG. 1, the earphone may include a processor 1001, for example, a CPU, a communication bus 1002, a user interface 1003, a network interface 1004, and a memory 1005. The communication bus 1002 is configured to implement connection and communication between those components. The user interface 1003 may include a display screen, an input unit such as a keyboard, and the user interface 1003 may optionally further include a standard wired interface and a wireless interface. The network interface 1004 may optionally include a standard wired interface, and a wireless interface (such as a Wi-Fi interface). The memory 1005 may be a high-speed RAM memory or a non-volatile memory, such as a magnetic disk memory. The memory 1005 may optionally be a storage device independent of the foregoing processor 1001.

It may be understood by those skilled in the art that the hardware structure of the earphone shown in FIG. 1 does not constitute a limitation on the earphone, which may include more or fewer components than illustrated, or have some components combined, or have different component arrangement.

As shown in FIG. 1, the memory 1005, as a storage medium, may include an operating system, a network communication module, a user interface module, and a step counting program of the earphone. The operating system is a program for managing and controlling the earphone and the software resource, and supports the steps of the network communication module, the user interface module, the step counting program and other programs or software. The network communication module is for managing and controlling the network interface 1004. The user interface module is for managing and controlling the user interface 1003.

In the hardware structure of the earphone shown in FIG. 1, the network interface 1004 is mainly for connecting a back-end server and carrying out data communication with the back-end server. The user interface 1003 is mainly for connecting a client and carrying out data communication with the client. The processor 1001 can call the counting program of the earphone stored in the memory 1005 and execute the following steps:

acquiring vibration pulse signals through a feedback microphone of the earphone;

determining valid pulse signals according to the vibration pulse signals, and counting steps according to a number of the valid pulse signals;

Further, the operation of determining the valid pulse signals according to the vibration pulse signals includes:

acquiring amplitudes of the vibration pulse signals, and determining whether the amplitudes of the vibration pulse signals are larger than or equal to a preset amplitude threshold;

in responding to that the amplitudes of the vibration pulse signals are larger than or equal to the preset amplitude threshold, determining that the vibration pulse signals are the valid pulse signals.

Further, the operation of counting steps according to the number of valid pulse signals includes:

incrementing a number of steps by one each time an valid pulse signal is determined.

Further, the earphone further includes a high-pass filter, before the operation of acquiring the vibration pulse signals through the feedback microphone of the earphone, the following operations are also included:

receiving original pulse signals through the feedback microphone of the earphone;

filtering the original pulse signals through the high-pass filter to obtain the vibration pulse signals.

Further, after the operation of determining the valid pulse signals according to the vibration pulse signals, and counting the steps according to the number of valid pulse signals, the following operations are also included:

determining whether a number of valid pulse signals in a first preset duration is larger than or equal to a preset number threshold;

in responding to that the number of valid pulse signals in the first preset duration is larger than or equal to the preset number threshold, transmitting a number of steps determined according to the number of valid pulse signals in the first preset duration to the mobile terminal in communication with the earphone, for the mobile terminal to update the number of steps of a wearer.

Further, after the operation of determining the valid pulse signals according to the vibration pulse signals, and counting the steps according to the number of valid pulse signals, the following operations are also included:

transmitting vibration pulse signals acquired by the earphone in a second preset duration to a mobile terminal in communication with the earphone, for the mobile terminal to determine strengths of footsteps of the wearer in the second preset duration according to an amplitude of each vibration pulse signal in the second preset duration, and output a footstep health prompt according to the strengths of the footsteps.

Further, after the operation of determining the valid pulse signals according to the vibration pulse signals, and counting the steps according to the number of valid pulse signals, the following operations are also included:

transmitting vibration pulse signals acquired by the earphone in a third preset duration to a mobile terminal in communication with the earphone, for the mobile terminal to determine a walking speed of the wearer in the third preset duration according to a pulse period of each vibration pulse signal in the third preset duration, and output a walking prompt according to the walking speed.

Further, before the operation of acquiring the vibration pulse signals through the feedback microphone of the earphone, the following operations are also included:

detecting whether the earphone is worn;

in responding to that the the earphone is worn, executing the operation of acquiring the vibration pulse signals through the feedback microphone of the earphone.

The specific implementation mode of the earphone is basically the same as that of the step counting method of the earphone, and details are not described herein.

The present application further provides a step counting method of an earphone based on the above-mentioned earphone.

Referring to FIG. 2, FIG. 2 is a schematic flowchart of a first embodiment of the step counting method of the earphone according to the present application.

The embodiments of the present application provide an embodiment of the step counting method of the earphone. It should be noted that, although the logic sequence is shown in the flowchart, in some cases, the operations shown or described can be executed in an order different from the logic sequence shown here.

In various embodiments of the step counting method of the earphone, the executive body may be the earphone or a controller, or may be an earphone control system. For ease of description, in the present embodiment, the controller is used as the executive body.

The step counting method of the earphone is applied to the earphone which includes a feedback microphone. The step counting method of the earphone includes the following operations:

operation S10, acquiring vibration pulse signals through the feedback microphone of the earphone.

When the user is in exercise, in order to record the motion state of the user, the user needs to wear an terminal which has the step counting function or a wearable device for sports to record the steps of the user, thus, when the user enjoys music through the earphone during exercise, the user needs to wear a plurality of electronic devices if he/she wants to know his/her steps. How to reduce the electronic devices worn by the user is an urgent problem to be solved.

In order to solve the problem that in the related art, there are too many electronic devices needed to be worn by the user during exercise, the embodiments of the present application provides a step counting method of an earphone, so that the earphone has both an audio playing function and a step counting function through a feedback microphone of the earphone, thus, the user does not need to wear another counting equipment for counting steps when he/she exercises with wearing the earphone, thus, the problem in the related art that a user needs to wear multiple electronic equipments when he/she needs to both listen to the audio and count steps during exercise is solved. In addition, the feedback microphone of the earphone is used for step counting, the user does not need to purchase other pedometer equipment, thus the cost for step counting can be reduced.

The step counting method of the earphone in this embodiment is suitable for a wireless earphone with a feedback microphone, such as a true wireless stereo (TWS) earphone, a head-mounted headphone, a neck-mounted headphone and the like, and can even be suitable for a wired earphone. In the following embodiments, a TWS earphone is used as an example for description. A TWS noise reduction earphone with a noise reduction function is generally provided with a feedback microphone, and the feedback microphone is usually arranged on an inner side of the earphone, thus, when the user uses the earphone, the feedback microphone is located in a closed cavity formed by the ear and the earphone, and separated from the external high-frequency interference noise.

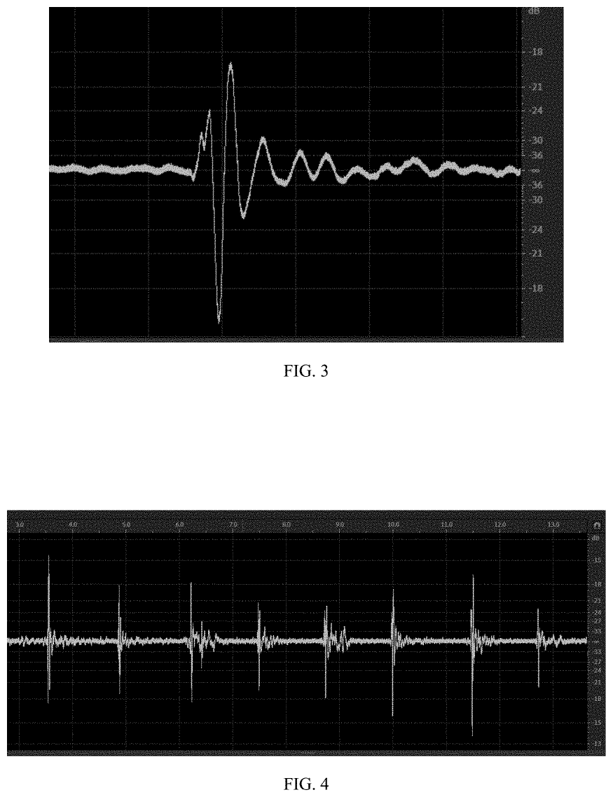

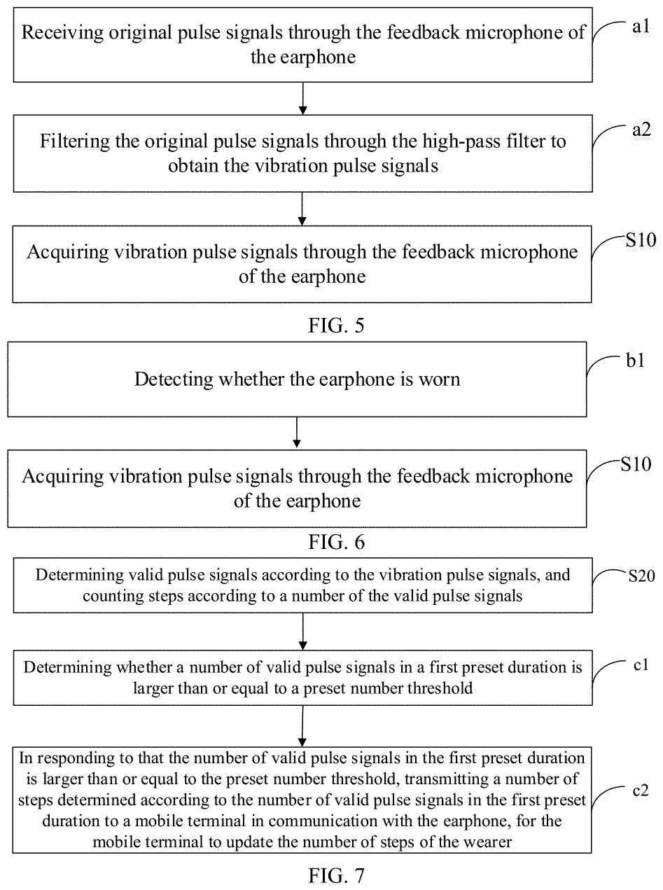

The microphone can be understood as a transducer for converting acoustic energy into electric energy. A diaphragm is arranged in the microphone, the external sound is transmitted to the diaphragm through air, vibration is generated by the diaphragm, and the mechanical vibration is converted into a voltage signal by the transducer. When walking, the body will naturally generate regular vibration, and when the wearer's body vibrates each time, the volume of the cavity where the feedback microphone of the earphone locates also changes along with the vibration of the wearer's body, the air in the cavity is compressed, and then the diaphragm of the feedback microphone is pressed, so that the feedback microphone receives the medium-frequency pulse signal or the high-frequency pulse signal similar to that shown in FIG. 3. In the continuous exercise process, the feedback microphone receives the continuous pulse signals as shown in FIG. 4.

Furthermore, the earphone also includes a high-pass filter. Referring to FIG. 7, before operation S10, the method further includes:

operation a1, receiving original pulse signals through the feedback microphone of the earphone;

operation a2, filtering the original pulse signals through the high-pass filter to obtain the vibration pulse signals.

In this embodiment, the earphone further includes a high-pass filter. The high-pass filter is also called a low-cutoff filter or a low-stop filter, which allows the frequencies higher than a certain cut-off frequency to pass through, and greatly attenuates the low frequencies, so that unnecessary low-frequency components in the signals or the low-frequency interference can be removed.

Due to the fact that the body not only generates vibration when the wearer walks, but also generates tiny vibration because of respiration, heartbeat, speaking, body shaking and the like, this vibration is relatively smaller than the body vibration generated when walking, but it also make the feedback microphone receive the corresponding low-frequency pulse signals. In order to reduce the workload of subsequent data analysis, and improve the efficiency of system data analysis. After the feedback microphone of the earphone receives the original pulse signals, the high-pass filter filters the original pulse signals based on the cut-off frequency, and the low-frequency pulse signals in the original pulse signals are filtered out to obtain the vibration pulse signals.

Before this, a developer can respectively collect a large number of pulse signals when walking and a large number of pulse signals caused by respiration, heartbeat, speaking, body shaking and the like, and compare the pulse signals in various scenarios to determine the cut-off frequency for distinguishing the pulse signals when walking from the pulse signals of other tiny vibration scenarios, for example, the cut-off frequency can be set to be any value between 280 Hz and 320 Hz, such as 300 Hz.

Further, Referring to FIG. 6, before operation S10, the method further includes:

operation b1, detecting whether the earphone is worn;

in responding to that the earphone is worn, executing the operation of acquiring the vibration pulse signals through the feedback microphone of the earphone.

In this embodiment, the earphone further includes a wearing detection module for detecting whether the earphone is worn, the wearing detection module can be an infrared sensor or a photoelectric sensor. When the wearing detection module detects the human ear, the wearing detection module sends a trigger signal, so that the earphone can determine the earphone is worn according to the trigger signal, and then the operation S10 is triggered.

According to this embodiment of the present application, whether the earphone is worn is detected, only when the earphone is worn, the vibration pulse signals can be obtained through the feedback microphone, rather than leaving the feedback microphone to be always turned on, the power consumption of the earphone can be reduced, and the endurance capability of the earphone can be further improved. The vibration pulse signals can be acquired through the feedback microphone only when the earphone is worn, and then the vibration pulse signals are counted, so that the feedback microphone of the earphone can be prevented from detecting the high-frequency noises of the external environment when not being worn, and counting the vibration pulse signals generated by the high-frequency noises of the external environment to reduce the accuracy of the earphone counting steps.

Operation S20, determining valid pulse signals according to the vibration pulse signals, and counting steps according to a number of the valid pulse signals.

In this embodiment, the vibration pulse signals may include valid pulse signals and invalid pulse signals, and the difference between the two type of pulse signals is that the amplitudes of the valid pulse signals are larger than or equal to a preset amplitude threshold, and the amplitudes of the invalid pulse signals are less than the preset amplitude threshold. The amplitude of a pulse signal refers to a distance between a peak and a trough of a pulse signal wave. The preset amplitude threshold is a critical value which reflects the minimum amplitude caused by walking and is determined by a developer in advance according to a large number of pulse signals generated when walking, for example, the preset amplitude threshold can be any value between 20 dB and 40 dB, such as 30 dB. The pulse signals with the amplitude larger than or equal to the critical value can be considered to be generated by vibration when the wearer walks, and the pulse signal with the amplitude smaller than the critical value can be considered to be generated by non-walking vibration. If the invalid pulse signals are also used as a basis for counting, it will result in a great gap between the counted steps and the actual steps. Thus, after the vibration pulse signals are acquired, whether the amplitude of each vibration pulse signal is larger than or equal to the preset amplitude threshold or not is determined. Only the vibration pulse signals with the amplitude larger than or equal to the preset amplitude threshold can be determined to be the valid pulse signals, and then step counting is carried out according to the number of valid pulse signals. Generally, when one valid pulse signal is determined, the number of steps is incremented by one.

Furthermore, in order to improve the accuracy of the earphone counting steps, a gravity sensor or an acceleration sensor can be arranged in the earphone, or a gravity sensor or an acceleration sensor arranged in a mobile terminal which is in communication with the earphone is also used to count the steps together, and the step counting is carried out with a plurality of step counting modes.

According to this embodiment of the present application, vibration pulse signals are acquired through a feedback microphone of the earphone; valid pulse signals are determined according to the vibration pulse signals, and step counting is carried out according to a number of the valid pulse signals. By utilizing the feedback microphone of the earphone, the earphone has an audio playing function and a step counting function, so that when the user exercises in the state of wearing the earphone, the user does not need to wear another counting equipment for counting, thereby the problem that in the related art, the user needs to wear multiple electronic equipment when doing exercise is solved. In addition, the feedback microphone of the earphone is used for step counting, and the user does not need to purchase another pedometer equipment, so that the cost for counting steps can be reduced.

Further, a second embodiment of the step counting method of the earphone of the present application is provided. Referring to FIG. 7, after operation S20, the method further includes:

operation c1, determining whether a number of valid pulse signals in a first preset duration is larger than or equal to a preset number threshold;

operation c2, in responding to that the number of valid pulse signals in the first preset duration is larger than or equal to the preset number threshold, transmitting a number of steps determined according to the number of valid pulse signals in the first preset duration to a mobile terminal in communication with the earphone, for the mobile terminal to update the number of steps of the wearer.

In this embodiment, after the earphone counts the steps according to the number of valid pulse signals, the number of steps can be sent to the mobile terminal in communication with the earphone each time the number of steps is incremented by 1, so that the mobile terminal updates the number of steps of the wearer for the the user to view.

However, the power consumption of the electronic device is gradually increased along with the increase of the number of interactions, that is, the higher the interaction frequency, the higher the power consumption, and the shorter the endurance time. Considering the above power consumption problem, in this embodiment, on the premise of ensuring that the user can normally view the number of steps of motion, the power consumption of the electronic device is reduced as much as possible, the endurance time of the earphone and the mobile terminal is prolonged, thus, the power consumption of the electronic device can be reduced by reducing the interaction frequency of the earphone interacting with the mobile terminal.

Specifically, whenever the number of valid pulse signals in the first preset duration reaches the preset number threshold, the number of steps determined according to the number of valid pulse signals in the first preset duration is transmitted to the mobile terminal in communication with the earphone, so that the mobile terminal updates the number of steps of the wearer for the user to view. The first preset duration and the preset number threshold can be determined by a developer according to two factors, namely the power consumption and the frequency of the user viewing the number of steps, and this embodiment is not specifically limited to this.

It can be understood that if the number of valid pulse signals in the first preset duration does not reach the preset number threshold, the earphone will temporarily not synchronize the number of steps in the first preset duration to the mobile terminal until the first preset duration is over, whether the number of steps in the first preset duration is larger than 0 is determined, if the number of steps in the first preset duration is larger than 0, the number of steps in the first preset duration is sent to the mobile terminal, otherwise, the number of steps in the first preset duration is not sent to the mobile terminal, so that the interaction frequency can be further reduced, and the power consumption is reduced.

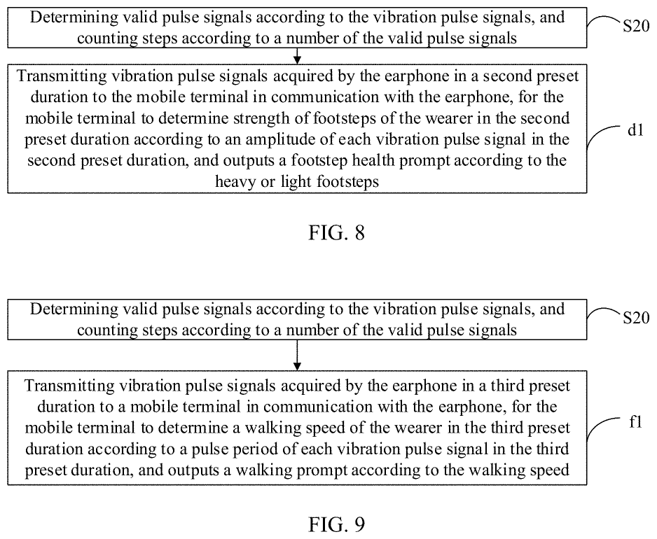

Further, referring to FIG. 8, after operation S20, the method further includes:

operation d1, transmitting vibration pulse signals acquired by the earphone in a second preset duration to the mobile terminal in communication with the earphone, for the mobile terminal to determine strength of footsteps of the wearer in the second preset duration according to an amplitude of each vibration pulse signal in the second preset duration, and outputs a footstep health prompt according to the strength of footsteps.

In this embodiment, the earphone temporarily stores the vibration pulse signals in the second preset duration, and sends the vibration pulse signals in the second preset duration to the mobile terminal in communication with the earphone, after the second preset duration is over or an instruction of obtaining footstep information is received, the earphone sends the temporarily stored vibration pulse signals in the second preset duration to the mobile terminal in communication with the earphone. After receiving the vibration pulse signals in the second preset duration, the mobile terminal obtains and analyzes the amplitude of each vibration pulse signal, and then determines an average value of the amplitudes of the vibration pulse signals in the second preset duration. Since the amplitudes of the vibration pulse signals reflect whether footsteps of the wearer are heavy or light, the larger the amplitude are, the heavier the footsteps are. Therefore, the average value reflects an average strength of the footsteps of the wearer in the second preset duration. After obtaining the average strength of the footsteps of the wearer in the second preset duration, the average strength of the footsteps can be compared with a normal strength range of footstep of the wearer to determine whether the average strength of the wearer in the second preset duration exceeds the normal strength range of footstep, and then a corresponding footstep health prompt is given, for example, if the average strength of the footsteps of the wearer in the second preset duration is greater than an upper limit value of the normal strength range of footstep, which means that the wearer is exercising too hard, and the footstep health prompt output can be “your average strength of the footsteps is too large, please do moderate exercise”.

The normal strength range of footstep can be determined according to indexes such as height, weight, age and the like input by the wearer in advance.

Further, the manner of outputting the footstep health prompt may be outputting by the mobile terminal through displaying texts and/or an image on an interface, or may be voice outputting by the mobile terminal, or may be that the mobile terminal sends the voice prompt to the earphone, and the earphone voice outputs the voice, which is not specifically limited in this embodiment.

In the embodiment, the strength of the footsteps are determined according to the vibration pulse signals, so that the footstep health prompt is output according to the strength of the footsteps, the diversity of the pedometer function can be enriched, and the intelligence of the pedometer can be improved.

Further, referring to FIG. 9, after operation S20, the method further includes:

operation f1, transmitting vibration pulse signals acquired by the earphone in a third preset duration to a mobile terminal in communication with the earphone, for the mobile terminal to determine a walking speed of the wearer in the third preset duration according to a pulse period of each vibration pulse signal in the third preset duration, and outputs a walking prompt according to the walking speed.

In the present embodiment, the earphone temporarily stores the vibration pulse signals in the third preset duration, and sends the vibration pulse signals in the third preset duration to the mobile terminal in communication with the earphone, after the third preset duration is over or an instruction of obtaining walking speed is received, the earphone sends the temporarily stored vibration pulse signals in the third preset duration to the mobile terminal in communication with the earphone. After receiving the vibration pulse signals in the third preset duration, the mobile terminal obtains and analyzes the pulse period of each vibration pulse signal, and then determines an average value of the pulse periods of the vibration pulse signals in the third preset duration. Since the pulse periods of the vibration pulse signals reflects the walking speed of the wearer, the smaller the pulse periods are, the faster the walking speed is, therefore, the average value reflects an average walking speed of the wearer within the third preset duration. After obtaining the average walking speed of the wearer in the third preset duration, the average walking speed can be compared with a normal walking speed range of the wearer to determine whether the average walking speed of the wearer in the third preset duration exceeds the normal walking speed range, and then a corresponding walking prompt is given, for example, if the average walking speed of the wearer in the third preset duration is greater than an upper limit value of the normal walking speed range, the output walking prompt can be “your walking speed is large, please caution”.

The normal walking speed range can be determined according to indexes such as height, weight, age and the like input by the wearer in advance, and can also be determined according to historical walking data of the wearer.

It can be understood that after the mobile terminal receives the vibration pulse signals in the third preset duration, acquires and analyzes the pulse period of each vibration pulse signal, the maximum walking speed and the minimum walking speed of the wearer in the third preset duration can be determined, and the maximum walking speed, the minimum walking speed and the average walking speed are fed back to the wearer, so that the wearer can know the walking condition of the wearer in time.

Further, the manner of outputting the walking prompt may be outputting by the mobile terminal through displaying texts and/or an image on an interface, or may be voice outputting by the mobile terminal, or may be that the mobile terminal sends the voice prompt to the earphone, and the earphone voice outputs the voice, which is not specifically limited in this embodiment.

In the embodiment, the walking speed is determined according to the vibration pulse signals, so that the walking prompt is output according to the walking speed, the diversity of the pedometer function can be enriched, and the intelligence of the pedometer can be improved.

In addition, the embodiments of the application further provide a non-transitory storage medium.

The non-transitory storage medium stores a step counting program of an earphone, when the step counting program of the earphone is executed by a processor, the operations of the step counting method of the earphone as described above are implemented.

The specific implementation of the storage medium is basically the same as the embodiments of the step counting method of the earphone, and details are not described herein again.

The embodiments of the present application are described above in conjunction with the accompanying drawings, but the present application is not limited to the specific embodiments described above, and the above-mentioned specific embodiments are merely illustrative and not intended to limit the scope of the present application. Any equivalent structure or equivalent process transformation made using the description and drawings of the present application, or any direct or indirect application in other related technical fields, is included in the claimed scope of the present application.

What is claimed is:

1. A step counting method of an earphone applied to an earphone, wherein the earphone comprises a feedback microphone, and the step counting method of the earphone comprises:
acquiring vibration pulse signals through the feedback microphone of the earphone;
determining valid pulse signals according to the vibration pulse signals, and counting steps according to a number of the valid pulse signals.

2. The step counting method of the earphone according to claim 1, wherein the determining valid pulse signals according to the vibration pulse signals comprises:
acquiring amplitudes of the vibration pulse signals, and determining whether the amplitudes of the vibration pulse signals are larger than or equal to a preset amplitude threshold;
in responding to that the amplitudes of the vibration pulse signals are larger than or equal to the preset amplitude threshold, determining that the vibration pulse signals are the valid pulse signals.

3. The step counting method of the earphone according to claim 2, wherein the counting the steps according to the number of valid pulse signals comprises:
incrementing a number of steps by one each time an valid pulse signal is determined.

4. The step counting method of the earphone according to claim 1, wherein the earphone further comprises a high-pass filter, and before the acquiring the vibration pulse signals through the feedback microphone of the earphone, the method further comprises:
receiving original pulse signals through the feedback microphone of the earphone;
filtering the original pulse signals through the high-pass filter to obtain the vibration pulse signals.

5. The step counting method of the earphone according to claim 1, wherein after the determining the valid pulse signals according to the vibration pulse signals, and counting the steps according to the number of valid pulse signals, the method further comprises:
determining whether a number of valid pulse signals in a first preset duration is larger than or equal to a preset number threshold;
in responding to that the number of valid pulse signals in the first preset duration is larger than or equal to the preset number threshold, transmitting a number of steps determined according to the number of valid pulse signals in the first preset duration to a mobile terminal in communication with the earphone, for the mobile terminal to update the number of steps of a wearer.

6. The step counting method of the earphone according to claim 1, wherein after the determining the valid pulse signals according to the vibration pulse signals, and counting the steps according to the number of valid pulse signals, the method further comprises:
transmitting vibration pulse signals acquired by the earphone in a second preset duration to a mobile terminal in communication with the earphone, for the mobile terminal to determine strengths of footsteps of the wearer in the second preset duration according to an amplitude of each vibration pulse signal in the second preset duration, and output a footstep health prompt according to the strengths of the footsteps.

7. The step counting method of the earphone according to claim 1, wherein after the determining the valid pulse signals according to the vibration pulse signals, and counting the steps according to the number of valid pulse signals, the method further comprises:
transmitting vibration pulse signals acquired by the earphone in a third preset duration to a mobile terminal in communication with the earphone, for the mobile terminal to determine a walking speed of the wearer in the third preset duration according to a pulse period of each vibration pulse signal in the third preset duration, and output a walking prompt according to the walking speed.

8. The step counting method of the earphone according to claim 1, wherein before the acquiring the vibration pulse signals through the feedback microphone of the earphone, the method further comprises:
detecting whether the earphone is worn;
in responding to that the the earphone is worn, executing the acquiring the vibration pulse signals through the feedback microphone of the earphone.

9. An earphone, comprising a feedback microphone, a memory, a processor, and a step counting program of the earphone stored in the memory and executable by the processor, wherein when the step counting program of the earphone is executed by the processor, operations of the step counting method of the earphone according to claim 1 are implemented.

10. The earphone according to claim 9, wherein the determining valid pulse signals according to the vibration pulse signals comprises:
acquiring amplitudes of the vibration pulse signals, and determining whether the amplitudes of the vibration pulse signals are larger than or equal to a preset amplitude threshold;
in responding to that the amplitudes of the vibration pulse signals are larger than or equal to the preset amplitude threshold, determining that the vibration pulse signals are the valid pulse signals.

11. The earphone according to claim 10, wherein the counting the steps according to the number of valid pulse signals comprises:
incrementing a number of steps by one each time an valid pulse signal is determined.

12. The earphone according to claim 9, wherein the earphone further comprises a high-pass filter, and before the acquiring the vibration pulse signals through the feedback microphone of the earphone, when the step counting program of the earphone is executed by the processor, following operations are implemented:
receiving original pulse signals through the feedback microphone of the earphone;
filtering the original pulse signals through the high-pass filter to obtain the vibration pulse signals.

13. The earphone according to claim 9, wherein after the determining the valid pulse signals according to the vibration pulse signals, and counting the steps according to the number of valid pulse signals, when the step counting program of the earphone is executed by the processor, following operations are implemented:
determining whether a number of valid pulse signals in a first preset duration is larger than or equal to a preset number threshold;
in responding to that the number of valid pulse signals in the first preset duration is larger than or equal to the preset number threshold, transmitting a number of steps determined according to the number of valid pulse signals in the first preset duration to a mobile terminal in communication with the earphone, for the mobile terminal to update the number of steps of a wearer.

14. A non-transitory storage medium storing a step counting program of an earphone, wherein when the step counting program of the earphone is executed by a processor, operations of the step counting method of the earphone according to claim 1 are implemented.

15. The non-transitory storage medium according to claim 14, wherein the determining valid pulse signals according to the vibration pulse signals comprises:
acquiring amplitudes of the vibration pulse signals, and determining whether the amplitudes of the vibration pulse signals are larger than or equal to a preset amplitude threshold;
in responding to that the amplitudes of the vibration pulse signals are larger than or equal to the preset amplitude threshold, determining that the vibration pulse signals are the valid pulse signals.

16. The non-transitory storage medium according to claim 15, wherein the counting the steps according to the number of valid pulse signals comprises:
incrementing a number of steps by one each time an valid pulse signal is determined.

17. The non-transitory storage medium according to claim 14, wherein the earphone further comprises a high-pass filter, and before the acquiring the vibration pulse signals through the feedback microphone of the earphone, when the step counting program of the earphone is executed by the processor, following operations are implemented:
receiving original pulse signals through the feedback microphone of the earphone;
filtering the original pulse signals through the high-pass filter to obtain the vibration pulse signals.

18. The non-transitory storage medium according to claim 14, wherein after the determining the valid pulse signals according to the vibration pulse signals, and counting the steps according to the number of valid pulse signals, when the step counting program of the earphone is executed by the processor, following operations are implemented:
determining whether a number of valid pulse signals in a first preset duration is larger than or equal to a preset number threshold;
in responding to that the number of valid pulse signals in the first preset duration is larger than or equal to the preset number threshold, transmitting a number of steps determined according to the number of valid pulse signals in the first preset duration to a mobile terminal in communication with the earphone, for the mobile terminal to update the number of steps of a wearer.
